(19) United States
(12) Patent Application Publication
(10) Pub. No.: US 2026/0234453 A1
(43) Pub. Date: Aug. 13, 2026

(54) TWO-COMPONENT POLYURETHANE ADHESIVE WITH DURABLE ADHESION TO INORGANIC SUBSTRATES

(71) Applicant: DDP SPECIALTY ELECTRONIC MATERIALS US, LLC, Wilmington, DE (US)

(72) Inventors: Felix KOCH, Freienbach (CH); Beda STEINER, Freienbach (CH); Stefan SCHMATLOCH, Freienbach (CH); Maria UZUNSKA, Freienbach (CH)

(21) Appl. No.: 19/153,523

(22) PCT Filed: Mar. 1, 2024
(86) PCT No.: PCT/US2024/017986

§ 371 Date: Aug. 4, 2025

Related U.S. Application Data
(60) Provisional application No. 63/490,550, filed on Mar. 16, 2023.

(51) Int. Cl. C09J 175/08; C08G 18/32; C08G 18/40; C08G 18/48; C08G 18/62; C08G 18/66; C08G 18/72; C08G 18/73; C08G 18/76; C08K 5/5435; C08K 5/548; C09J 5/00; C09J 11/06

(52) U.S. Cl. CPC C09J 175/08; C08G 18/3206; C08G 18/4063; C08G 18/4837; C08G 18/4854; C08G 18/6204; C08G 18/6674; C08G 18/722; C08G 18/73; C08G 18/7671; C09J 5/00; C09J 11/06; C08K 5/5435; C08K 5/548

(57) ABSTRACT

Two-component polyurethane adhesive with limited or no silane adhesion promoter in polyol component with improved adhesion to uncoated inorganic substrates.

### BACKGROUND

Polyurethanes (PU) are a well-known type of adhesive that come in a two-component or 2K type. Such adhesives can be used in a variety of applications, for example in the construction of passenger vehicles, particularly when during construction the welding of two dissimilar materials is difficult or impossible to achieve. Generally, a 2K PU adhesive formulation has a first resin component that includes one or more isocyanates and a second curative part that includes one or more polyols. When the two components are mixed, the isocyanates and polyols react to form a cured adhesive. A polyurethane adhesive can be formulated to cure at room temperature or upon exposure to certain conditions.

As the adhesive cures, the adhesive can form a strong adhesive bond to many types of substrates. For certain applications, however, such as passenger vehicle construction, bonded assemblies are often heavy and large (spanning multiple meters for instance). As a result, the flexibility of the cured adhesive becomes important, as do other properties such as the contribution of the adhesive to overall part stiffness. The cured adhesive also needs to exhibit stable physical properties, such as Young's modulus, shear strength, and elongation at break, throughout temperature window that vehicles typically operated (e.g., −30° C. to 80° C.). Retaining desirable adhesive properties while obtaining sufficient bond strength, particularly between two dissimilar substrates such as inorganic substrates and plastics, is difficult, often requiring an expensive coating on the inorganic substrate to enable proper adhesion. A need in the in the art exists for an improvement that can obviate the need for expensive pretreatment of substrates prior to forming assemblies particularly on passenger vehicles.

### SUMMARY

Disclosed is an uncured adhesive formulation comprising: (a) a first component comprising an isocyanate and 0.4% to 5% of a silane adhesion promoter by weight of the first component; and (b) a second component comprising i) 10% to 80% of a polyol by weight of the second component, the polyol having a molecular weight of at least 400 g/mol, and ii) 1% to 15% of a diol by weight of the second component, the diol having a molecular weight of 200 g/mol or less. The second component can comprise less than 3% of a silane adhesion promoter by weight of the second component. The inventors surprisingly discovered that when limiting or eliminating the silane adhesion promoter from the second component, stable assemblies of two dissimilar substrates can be made without requirement surface pretreatment of coating of one or more of the dissimilar substrates.

The uncured adhesive formulation is in the form of a kit in which the first and second components are not mixed prior to use. The components of the kit can be co-packaged, packaged separately, or sold together or separately.

Also described is a cured adhesive made by mixing the first and second components of the adhesive formulation and allowing the mixture to cure. Similarly, described is process for curing the adhesive formulation comprising mixing the first and second components of the adhesive formulation and allowing the mixture to cure. Also disclosed are cured adhesives prepared by the described process.

Additionally, disclosed is a process in which the uncured or partially cured mixture is applied to an inorganic substrate prior to allowing the mixture to fully cure. Suitable and exemplary substrates include uncoated, corrosion-protected aluminum or steel. In addition, described is a process (and the product thereof) of forming an assembly in which the inorganic substrate having the adhesive formulation mixture applied thereon can be applied to a second substrate which is not inorganic and allowing the adhesive mixture to fully cure to form the bonded assembly with the cured adhesive therebetween.

### DETAILED DESCRIPTION

### 1. First (Isocyanate) Component

The first component of the adhesive formulation kit is the isocyanate component, abbreviated as “IsoC” in the Examples below. In general, the isocyanate component comprises an isocyanate such as a monomeric or polymeric isocyanate (or prepolymers thereof as discussed below) and an adhesion promoter as discussed more below.

### A. Monomeric Isocyanates

The isocyanate component can include any monomeric isocyanate commonly used with polyurethane technology. Non-limiting examples include m-phenylene diisocyanate; methylene diphenyl diisocyanate (MDI); 4,4′-methylenediphenyldiisocyanate; 2,2′-methylenediphenyldiisocyanate; 2,4-methylenediphenyldiisocyanate; toluene diisocyanate (TDI); toluene-2,4-diisocyanate; toluene-2,6-diisocyanate; naphthyl-ene-1,5-diisocyanate; methoxyphenyl-2,4-diisocyanate; diphenyl-methane-4,4′-diisocyanate; diphenylmethane-2,4′-diisocyanate; 4,4′-bi-phenylene diisocyanate; 3,3′-dimethoxy-4,4′-biphenyl diisocyanate; 3,3′-dimethyl-4-4′-biphenyl diisocyanate; 3,3′-dimethyl-diphenyl methane-4,4′-diisocyanate; 4,4′,4″-triphenyl methane triisocyanate; toluene-2,4,6-triisocyanate; 4,4,-dimethyl-di-phenylmethane-2,2,5,5′-tetraisocyanate; and mixtures thereof. The monomeric isocyanate can be present in the first component in an amount ranging from 0-30% by weight of the first component, e.g., 1-25%, 2-20%, 5-20%, 10-20%, or 10-15%.

### B. Polymeric Isocyanates

Any polymer of a monomeric isocyanate can also be used, including in combination with monomeric isocyanates. Examples include any derivative or polymer of the above described isocyanates. Other examples include polyisocyanates that contain urethane, urea, biuret, caibodiimide, uretoneimine, allophonate or other groups formed by reaction of isocyanate groups. The isocyanate component can also include polymeric MDI (a mixture of MDI and polyMDI that is commonly referred to as “polymeric MDF”). Other examples include “liquid MDI” products that are mixtures of MDI and polyMDI derivatives that have biuret, carbodiimide, uretoneimine or allophonate linkages. The polymeric isocyanate can be present in the first component in an amount ranging from 0-30% by weight of the first component, e.g., 1-25%, 2-20%, 5-20%, 10-20%, or 10-15%.

### C. Isocyanate-Terminated Prepolymers

The isocyanate component can include an isocyanate prepared by reacting a monomeric or polymeric isocyanate with a polyol, or a lower molecular weight diol or triol. For example, any one of the polyols described below with reference to the polyol component; or for example any of the polyols described in WO2016205252 (A1), incorporated by reference, can be used.

The polyol used to make the isocyanate-terminated prepolymer can have a molecular weight (MW, in g/mol) of from 200 to 10,000, a MW of from 800 to 8,000, a MW of from 800 to 6,000, e.g., 200-3,000, 500-3,000, or 1,000-3,000 g/mol. In addition, the polyol may can a nominal functionality of from 2 to 3. The polyol can also have an OH number ranging from 20-80 mg KOH/g, e.g., 25-75, 30-70, 30-60, or 40-60 mg KOH/g.

The reaction of an isocyanate and a polyol can produce isocyanate-containing prepolymers having a polyether segment capped with the isocyanate, so the polymers have terminal isocyanate groups. Each prepolymer molecule contains a polyether segment that corresponds to the structure, after removal of hydroxyl groups, of a polyol used in the prepolymer-forming reaction. If a mixture of polyols is used, a mixture of prepolymer molecules can be formed. For example, in addition to the prepolymer that can be end-capped with a polyol, in other embodiments a wide variety of other prepolymers can be made by molecular weight build-up. For example, the prepolymer can have one diisocyanate in the middle of the chemical structure of the prepolymer with two hydroxy groups attached to the ends of the structure which can be end-capped with isocyanates.

In one embodiment, for example, the prepolymer can include MDI end-capped prepolymers formed from EO (ethylene oxide) or PO (propylene oxide) based polyols such as polymeric diols, triols, or mixtures thereof. The resulting prepolymers can have an equivalent weight (EW) of up to 5,000, from 1,000 to 4,000, and from 2,000 to 3,500. Molecular weight values as discussed here and elsewhere, unless specified otherwise, refer to number average molecular weight as measured by gel-permeation chromatography (GPC) with a triple detector for absolute molecular weight calibration.

In another embodiment, the prepolymer can be prepared by combining: (1) a polyol or a mixture of polyols with (2) a isocyanate or polyisocyanate having a low equivalent weight (e.g., an equivalent weight of less than 350) or a mixture of thereof. The low equivalent weight isocyanate, generally, have an isocyanate equivalent weight of up to 350, from 80 to 350, from 80 to 250, from 80 to 200, or from 80 to 180. The amount of such low-equivalent weight isocyanate that can be used can be significantly greater than is needed to simply cap the polyol(s) with isocyanate moieties.

After reaction, the above combination may produce a mixture of the prepolymer and unreacted starting low-equivalent weight isocyanates. If desired, an additional amount of isocyanate can then be blended into this prepolymer/unreacted low-equivalent weight mixture. For example, the mixture can be combined with one or more aliphatic isocyanates, such as an aliphatic isocyanate or polymer thereof based on hexamethylenediisocyanate. A more thorough discussion of prepolymer technology can be found in US 2020/0407611A1, which is incorporated by reference for its teaching of prepolymer technology.

### D. Adhesion Promoter

The isocyanate component can contain an adhesion promoter such as a silane, an epoxy silane, an aminosilane, or a combination thereof. The adhesion promoter can constitute, for example, 0.4 to 5% of the total weight of the isocyanate component. In some embodiments, the adhesion promoter can be present in the isocyanate component in an amount ranging from 0.5% to 5% by weight of the isocyanate component, e.g., 0.6-4%, 0.8-3%, 1-3%, or 2-3%.

Adhesion promoters include compounds with at least one functional group that has an attractive force to the surface of a desired substrate, a cured adhesive to be applied to the substrate, or both. Examples of adhesion promoters include a titanate, carboxylated branched or linear PEI, and silane compounds. Non-limiting examples include silane adhesion promoters with a reactive functional group such as epoxy silanes (e.g., gamma-glycidoxypropyltrimethoxysilane such as Silquest A 187) or mercapto silanes (e.g., gamma-mercaptopropyltrimethoxysilane such as Silquest A 189). In one embodiment, the adhesion promoter is not an aminosilane. In a further embodiment, the isocyanate component is free of any aminosilane. In a further embodiment, neither component of the kit contains any aminosilane.

### II. Second (Polyol) Component

The second component is the polyol component, abbreviated as “PolyC” in the Examples below. The second component in general comprises i) 10% to 80% of a polyol by weight of the second component, the polyol having a molecular weight of at least 400 g/mol; and ii) 1% to 15% of a diol by weight of the second component, the diol having a molecular weight of 200 g/mol or less. Although the polyol and diol may both have two hydroxyl groups per molecule in some embodiments, they are differentiated in that the diol has a lower molecular weight than the polyol.

### A. Polyol

In some embodiments, the second component comprises 15% to 75% of the polyol by weight of the second component. In other embodiments, the second component comprises 20% to 70% of the polyol by weight of the second component. In other embodiments, the second component comprises 25% to 65% of the polyol by weight of the second component. In other embodiments, the second component comprises 30% to 60% of the polyol by weight of the second component. In other embodiments, the second component comprises 35% to 55% of the polyol by weight of the second component. In other embodiments, the second component comprises 40% to 50% of the polyol by weight of the second component. In other embodiments, the second component comprises 45% to 50% of the polyol by weight of the second component.

The molecular weight of the polyol can vary. In some embodiments, the polyol has a molecular weight of 400 g/mol to 3,000 g/mol. In other embodiments, the polyol has a molecular weight of 500 g/mol to 2,500 g/mol. In other embodiments, the polyol has a molecular weight of 600 g/mol to 2,000 g/mol. In other embodiments, the polyol has a molecular weight of 700 g/mol to 1,900 g/mol. In other embodiments, the polyol has a molecular weight of 800 g/mol to 1,800 g/mol. In other embodiments, the polyol has a molecular weight of 900 g/mol to 1,700 g/mol. In other embodiments, the polyol has a molecular weight of 1,000 g/mol to 1,700 g/mol. In other embodiments, the polyol has a molecular weight of 1,100 g/mol to 1,700 g/mol. In other embodiments, the polyol has a molecular weight of 1,200 g/mol to 1,700 g/mol. In other embodiments, the polyol has a molecular weight of 1,300 g/mol to 1,700 g/mol. In other embodiments, the polyol has a molecular weight of 1,400 g/mol to 1,700 g/mol. In other embodiments, the polyol has a molecular weight of 1,500 g/mol to 1,700 g/mol.

In general, the polyol can be any polyol used with polyurethane technology. For example, the polyol can be any glycerin initiated propoxylated or ethoxylated polyol or any propoxylated or ethoxylated polyol prepared from alternative tri-functional and bis-functional starters. In some embodiments, the polyol can be a polyether polyol or mixture of polyether polyols. In other embodiments, the polyol can be a homopolymer or copolymer of propylene oxide, or a copolymer of propylene oxide with 70 wt % to 99 wt % propylene oxide and from 1 wt % to 30 wt % ethylene oxide. Such a copolymer of propylene oxide and ethylene oxide can be preferred if a single polyether polyol is present. If two or more polyether polyols are present, it can be preferred that at least one of the polyols is such a copolymer of propylene oxide and ethylene oxide. In the case of a copolymer, the propylene oxide and ethylene oxide can be randomly copolymerized, block copolymerized, or both. In some embodiments, 50% or more of the hydroxyl groups of the polyether polyol or mixture of polyether polyols are primary hydroxyl, with the remainder of the hydroxyl groups being secondary hydroxyl groups. In another embodiment, 70% or more of the hydroxyl groups in the polyether polyol or mixture thereof can be primary hydroxyl groups.

In additional embodiments, the polyol can be a polyetherpolyol or a polyester polyol. Other suitable polyols useful in the polyol component can include polypropylene based diols such as VORANOL 1010L with a molecular weight of 500 g/mol, VORANOL 2000L with an molecular weight of 1,000 g/mol, glycerin-initiated ethylene oxide based propoxylated triol VORANOL CP4610 with an average molecular weight of 1,600 g/mol; and mixtures thereof.

In certain specific embodiments, the polyol can be a glycerin-initiated ethylene oxide based propoxylated triol having a molecular weight of 1,500 g/mol to 1,700 g/mol, which can be present at 15% to 75%, 20% to 70%, 25% to 65%, 30% to 60%, 35% to 55%, 40% to 50%, or 45% to 50% by weight of the second component.

### B. Low Molecular Weight Diol

The diol having a molecular weight of 200 g/mol or less functions as a chain extender. The second component can comprise 1% to 15% of the diol by weight the second component. In some embodiments, the second component can comprise 2% to 14% of the diol by weight the second component. In other embodiments, the second component can comprise 3% to 12% of the diol by weight the second component. In other embodiments, the second component can comprise 4% to 10% of the diol by weight the second component. In other embodiments, the second component can comprise 5% to 8% of the diol by weight the second component. In other embodiments, the second component can comprise 6% to 8% of the diol by weight the second component.

In general, the diol can have at least two carbon atoms, can be branched, linear, or functionalized, and can have at least two hydroxyl groups per molecule. In some embodiments, the diol can be a linear or branched aliphatic diol having from 2-20 carbons, e.g., 2-18 carbons, 2-16 carbons, 2-14 carbons, 2-12 carbons, 2-10 carbons, 2-8 carbons, or 2-6 carbons. In various embodiments, the diol has a molecular weight of 20-200 g/mol, e.g., 20-150 g/mol, 40-150 g/mol, 50-130 g/mol, or 60-120 g/mol.

In some embodiments, the diol has the formula CₓH_{y}O_{z}, where x is an integer ranging from 2 to 20, y is an integer equal to x+m (m being an integer ranging from 4 to 12), and z is an integer equal to x−n (n ranging from 0 to 6). Non-limiting examples include monoethylene glycol (MEG), diethylene glycol, triethylene glycol, 1,2-propane diol, 1,3-propane diol, 2,3-dimethyl-1,3-propane diol, dipropylene glycol, tripropylene glycol, 1,4-butane diol, or 1,6-hexane diol. In one embodiment, the diol can be monoethylene glycol, 1,4-butanediol, or a mixture thereof.

### C. Adhesion Promoter

The inventors surprisingly discovered that the presence of an adhesion promoter in the polyol component of the adhesive formulation prior to curing the two components negatively impacts adhesive performance after curing, as determined for instance by the 3,000-hour salt spray test. Specifically, in some embodiments, the presence of a silane adhesion promoter negatively impacts adhesive performance. Silanes such as epoxy silanes, for example, are typically bifunctional organosilanes having a reactive epoxy group and a hydrolyzable alkoxy group. Generally, epoxy silanes are able to promote adhesion between organic polymers and inorganic materials such as metals, dyes, fillers, glass, and the like.

In some embodiments, the polyol component of the adhesive formulation includes a limited or no amount of any adhesion promoter such as a silane adhesion promoter. For example, in some embodiments, the polyol component of the adhesive formulation includes no more than 3% of any adhesion promoter such as a silane, by weight of the polyol component. In other embodiments, the polyol component of the adhesive formulation includes no more than 2.5% of any adhesion promoter such as a silane, by weight of the polyol component. In other embodiments, the polyol component of the adhesive formulation includes no more than 2% of any adhesion promoter such as a silane, by weight of the polyol component. In other embodiments, the polyol component of the adhesive formulation includes no more than 1.5% of any adhesion promoter such as a silane, by weight of the polyol component. In other embodiments, the polyol component of the adhesive formulation includes no more than 1% of any adhesion promoter such as a silane, by weight of the polyol component. In other embodiments, the polyol component of the adhesive formulation includes no more than 0.5% of any adhesion promoter such as a silane, by weight of the polyol component. In other embodiments, the polyol component of the adhesive formulation includes no more than 0.4% of any adhesion promoter such as a silane, by weight of the polyol component. In other embodiments, the polyol component of the adhesive formulation includes no more than 0.3% of any adhesion promoter such as a silane, by weight of the polyol component. In other embodiments, the polyol component of the adhesive formulation includes no more than 0.2% of any adhesion promoter such as a silane, by weight of the polyol component. In other embodiments, the polyol component of the adhesive formulation includes no more than 0.1% of any adhesion promoter such as a silane, by weight of the polyol component. In other embodiments, the polyol component of the adhesive formulation includes no more than 0.05% of any adhesion promoter such as a silane, by weight of the polyol component. Finally, in some embodiments, the polyol component of the adhesive formulation does not include any adhesion promoter such as a silane.

### III. Other Formulation Additives

Either component of the adhesive kit can optionally comprise a number of other additives to enable or enhance specific performance characteristics, curing behavior, morphological properties, and the like. In general, these additional additives can be present in the first component (the isocyanate component), the second component (the polyol component), or both. Non-limiting examples of suitable additives are discussed below.

### A. Scavengers and Compatibilizers

In one embodiment, optional additives useful in the formulation can include gas- and water-scavengers to avoid additional water uptake of the adhesive and to avoid NCO-water reaction. Such undesired reaction may result in blister formation in the adhesive due to CO₂ emission caused by the reaction of NCO with water. In another embodiment, compatibilizers can be used in the formulation to further improve the wetting performance as well as to improve the mixing between the polyol component and the isocyanate component. These optional additives and components, when used in the adhesive formulation, can be present in an amount generally in the range of from 0 wt % to 15 wt %; from 0.1 wt % to 10 wt %; or from 1 wt % to 5 wt %, either by weight of the entire formulation or by weight of either component thereof.

### B. Chemical Rheology Modifiers

Chemical rheology modifiers can be used in the formulation. Generally, for example, different grades of polyamine compounds with different molecular weights and functionalities can be used. In one embodiment, the polyamine compounds include for example any one of more of the following compounds: the trimer Jeffamine T-403 having a molecular weight of 403 g/mol, the dimer Jeffamine D-400 having a molecular weight of 400 g/mol, the dimer Jeffamine D200 having a molecular weight of 200 g/mol, and mixtures thereof. Chemical rheology modifiers can be used to provide a fast initial gelling of the formulation which in turn provides the benefit of good sag resistance. Additionally, the fast increase of viscosity upon curing the formulation reduces the risk of CO₂ formation in a heat accelerated curing process. The rheology modifier, when used in the adhesive formulation, can be present in an amount generally in the range of from 0 wt % to 15 wt %; from 0.1 wt % to 10 wt %; and from 1 wt % to 5 wt %, either by weight of the entire formulation or by weight of either component thereof.

### C. Catalysts

The adhesive formulation can include a catalyst capable of catalyzing the reaction of a hydroxyl group with an isocyanate group. The catalyst can be present in the isocyanate component, the polyol component, or both. In some examples, the catalyst is present in the polyol component. In other examples, the catalyst is present in the polyol component but not in the isocyanate component.

The catalyst can include, for example, one or more latent room temperature (25° C.) organometallic catalysts. The latent room temperature organometallic catalysts can contain tin, zinc, bismuth, or a combination thereof. For example, the latent room temperature organometallic catalyst can include one or more catalysts such as zinc alkanoates, bismuth alkanoates, dialkyl tin alkanoates, dialkyl tin mercaptides, dialkyl tin bis(alkyl-mercaptoacetates), dialkyltin thioglycolates, or mixtures thereof. Specific examples include dioctyltinmercaptide, dibutylmercaptidem, dibutylmercaptide, dibutylmercaptide, bis(dodecylthio)dimethylstannane, dimethytin bis(2-ethylhexylmercaptoacetate), dioctylcarboxylates, dioctyltinneodecanoate, and mixtures thereof.

Another catalyst useful in the adhesive formulation is any catalyst that can be further heat activated (referred to as “thermosensitive catalysts”) or otherwise catalyze the reaction. In one embodiment, such catalysts can include for example amines-based solid amine catalysts such as a cyclic amidine catalyst compound, e.g., 1,8-diazabicyclo[5.4.0]undec-7-ene (DBU), 1,5-diazabicyclo[4.3.0]non-5-ene, 2,4,6-tris-(dimethylaminomethyl)-phenol, and mixtures thereof.

In a further embodiment, the adhesive formulation can include a combination of a latent tin-containing catalyst and a thermosensitive amine-based catalysts. Both the tin-containing organic catalyst and the amine-based catalyst can be readily formulated into the isocyanate component, the polyol component, or both the isocyanate component and the polyol component.

In a further embodiment, any non-tin-based metal-organic catalyst which exhibits similar curing kinetics or catalytic profile of the tin-based catalyst described above can be used as the catalyst ingredient in the adhesive formulation. For example, useful bismuth-based catalysts include bismuth(III)-neodecanaote, and useful zinc-based catalysts include zinc-neodecanaote.

In yet another embodiment, non-tin-based catalysts or non-amine-based catalysts useful in the adhesive formulation include carboxylic acid blocked catalysts such as DBU carboxylic acid blocked catalysts. For example, a DBU carboxylic acid blocked catalyst can be TOYOCAT DB41 catalyst (a carboxylic DBU salt available from TOSOH), POLYCAT SA-102/10 (a carboxylic DBU salt available from Air Products), and mixtures thereof. Other useful catalysts include acid blocked amines including for example tertiary amines and organic acid-based catalysts such as TOYOCAT DB40, TOYOCAT DB60, and TOYOCAT DB70 available from TOSOH; 1H-1,2,4-triazole-based amine catalysts such as TOYOCAT DB30 available from TOSOH; and mixtures thereof. Any other known thermosensitive amine catalysts can also be used including TOYOCAT F22 available from TOSOH; triethylenediamine (TEDA); and mixtures thereof. In one embodiment, the catalyst useful can be selected from tin catalysts such as di-n-octyltin bis[isooctylmercaptoacetate]; and from amine catalysts such as POLYCAT SA 1/10, and TOYOCAT DB60; and mixtures thereof.

In general, the amount of the catalyst in the adhesive formulation can be in the range of from 0.005 wt % to 2.0 wt %; from 0.01 wt % to 1.0 wt %; and from 0.015 wt. % to 0.07 wt %, based on either i) the total weight of the formulation or ii) the total weight of the first or second component of the formulation (i.e., the polyol or isocyanate component). In one illustrative embodiment, for example when a tin catalyst such as di-n-octyltin bis[isooctylmercaptoacetate] is used in the adhesive formulation, the concentration of such catalyst in the formulation or in either component can be from 0.005 wt % to 1.0 wt %; from 0.02 wt % to 0.08 wt %; and from 0.03 wt. % to 0.05 wt based on the total weight of the formulation as a whole or either component thereof.

In another illustrative embodiment, when a thermosensitive amine catalyst such as POLYCAT SA 1/10 is used in the adhesive formulation, the concentration of such catalyst in the formulation can be from 0.01 wt % to 2.0 wt %; from 0.01 wt % to 1.0 wt %; and from 0.015 wt. % to 0.025 wt % based on the weight of the formulation as a whole or either component of the formulation.

In still another illustrative embodiment, when a catalyst such as TOYOCAT DB60 is used in the adhesive formulation, the concentration of such catalyst in the formulation can be from 0.01 wt % to 2.0 wt %; from 0.01 wt % to 1.0 wt %; and from 0.045 wt. % to 0.065 wt %, based on the weight of the formulation as a whole or either component of the formulation.

If the concentration of the catalyst is lower than 0.005 wt % by weight of the formulation as a whole, the catalyst used may not be effectively active in the formulation and the storage stability of the resulting formulation may be “poor,” that is, any residual water present in the formulation can deactivate the small amounts of catalyst. If the concentration of the catalyst is more than 2.0 wt %, the reaction of the components present in the formulation may be too quick resulting in a short open time, that is, an open time of for example less than 3 minutes may occur. In addition, a high catalyst level (e.g., greater than 2.0 wt %) in the formulation may lead to an increase in handling and formulation costs for the resulting formulation.

### D. Fillers

The adhesive formulation can optionally contain a filler. The filler can be a particulate filler. The particulate filler can be a solid material at room temperature, and is not soluble in the other ingredients of the polyol component or the isocyanate component. The filler can be a material that does not melt, volatilize, or degrade under the conditions of the curing reaction between the polyol and isocyanate components. The filler can be, for example, an inorganic filler such as glass, silica (e.g., fumed silica), boron oxide, boron nitride, titanium oxide, titanium nitride, fly ash, calcium carbonate, and various alumina-silicates including clays such as wollastonite and kaolin, and the like; metal particles such as iron, titanium, aluminum, copper, brass, bronze and the like; thermoset polymer particles such as polyurethane, cured particles of an epoxy, phenol-formaldehyde, or cresol-formaldehyde resin, crosslinked polystyrene, and the like; thermoplastics such as polystyrene, styrene acrylonitrile copolymers, polyimide, polyamide-imide, polyether ketone, polyether-ether ketone, polyethyleneimine, poly(p-phenylene sulfide), polyoxymethylene, polycarbonate and the like; and various types of carbon such as activated carbon, graphite, molecular sieve, carbon black and the like; and mixtures thereof.

The particulate filler can be in the form of particles having a size of from 50 nanometers (nm) to 100 micrometers (μm) in one embodiment. In other embodiments, the fillers may have a particle size (d50) of 250 nm or greater in one embodiment, 500 nm or greater in another embodiment and 1 μm or greater in still another embodiment. In other embodiments, the fillers can have a particle size (d50) of 50 μm or less, 25 μm or less, or 10 μm or less. Particles sizes are conveniently measured using dynamic light scattering methods, or laser diffraction methods for particles having a size below 100 nm.

In some embodiments, particulate filler particles can have an aspect ratio of up to 5, an aspect ratio of up to 2, or an aspect ratio of up to 1.5. In other embodiments, a portion or all of the filler particles can be grafted onto one or more of the polyether polyol(s) of the polyol component.

In general, when a filler is present in the adhesive formulation, the filler constitutes no more than 80 wt % of the total weight of the adhesive formulation. In other embodiments, the amount of the filler present in the adhesive formulation can be generally in the range of from 0.1 wt % to 80 wt %; from 0.1 wt % to 70 wt %; from 0.1 wt % to 60 wt %; from 0.1 wt % to 50 wt %; from 0.1 wt % to 40 wt %; from 0.1 wt % to 30 wt %; from 0.1 wt % to 25 wt %; or from 0.1 wt % to 20 wt %, based on the total weight of the components in the formulation.

The optional filler can be present in the isocyanate component, the polyol component, or both. For example, in one illustrative embodiment, the filler can be carbon black and a predetermined concentration of the carbon black can be present in the isocyanate component. When carbon black and no other filler is present in the isocyanate component, the carbon black filler can constitute, for example, from 1 wt % to 50 wt % of the isocyanate component; from 2 wt % to 40 wt %; from 5 wt % to 30 wt %; or from 10 wt % to 25 wt %, based on the weight of the isocyanate component.

In another illustrative embodiment, a predetermined concentration of filler can be present in the polyol component. When a filler is present in the polyol component, the filler can constitute, for example, from 1 wt % to 80 wt % of the polyol component; from 5 wt % to 70 wt %; from 10 wt % to 60 wt %; and from 20 wt % to 60 wt %, based on the weight of the polyol component.

The filler present in the polyol component can be the same as the filler in the isocyanate component; or the filler present in the polyol component can be different from the filler in the isocyanate component. For example, in one embodiment, a carbon black filler can be used in the isocyanate component in a concentration of, for example, from 15 wt % to 20 wt %; and a calcinated clay, calcium carbonate, or talc can be used in the polyol component in an amount of, for example, from 30 wt % to 60 wt %. The filler can be readily formulated into the isocyanate component, the polyol component, or both the isocyanate component and the polyol component.

### IV. Methods of Making Adhesive Components, Curing Adhesive, and Applying Adhesive to Substrates

In one embodiment, the process for preparing the 2K PU adhesive formulation of the present invention includes providing the isocyanate component and the polyol component. When provided as a kit, each adhesive component can be co-packaged or packaged separately. When the adhesive is ready to be used to bond substrates together, the components can be mixed, admixed, or blended together which results in a reaction product when the combination of components are cured. One or more additional optional components may be added to the formulation as desired. For example, at least one catalyst or at least one filler may be added to the adhesive formulation in either component before the components are mixed together or after the components are mixed.

While the amount of the isocyanate component and the amount of the polyol component useful in making the reaction product constituting the adhesive formulation can vary, once the isocyanate component and the polyol component are formulated (separately and individually) and the two components are ready for combining to form the reaction product adhesive, the isocyanate component and the polyol component can be mixed at a ratio ranging from 2:1 to 1:2, e.g., 1:1.

In making the components separately and individually, the ingredients and the can be mixed together in the desired concentrations discussed above at a temperature of from 5° C. to 80° C., e.g., 15° C. to 50° C., or room temperature for example. In one embodiment, the mixing of the ingredients can be carried out under vacuum. The order of mixing is not critical and two or more compounds can be mixed together followed by addition of the remaining ingredients. The adhesive formulation ingredients that make up the components can be mixed together by any known mixing process and equipment.

In another embodiment, the process of bonding two substrates can comprise forming a layer of the adhesive at a bondline between two substrates, and curing the layer at the bondline to form a cured adhesive bonded to each of the substrates. For example, the process can comprise combining the isocyanate component with the polyol component, forming a layer of the adhesive at a bondline between two substrates to form an assembly, allowing the adhesive layer to partially cure at the bondline at room temperature or by applying heat or infrared radiation to a portion of the assembly, and, in a subsequent and separate curing step, completing the cure of the adhesive layer.

The application of the adhesive to the substrates to be adhered together can be carried out by any known equipment such as metering/mixing/dispensing equipment which can apply a predetermined amount of the isocyanate component and the polyol component, in combination (as an adhesive), to selective portions of the substrates. For example, in an automotive manufacturing process, the two components can be provided in two separate containers. The first component can be drawn from one tank and, at the same time, the second components can drawn from another tank and both streams can be combined together using a known static or dynamic mixer as the combined adhesive components are applied to the substrates. The partial curing step can be performed by curing only one or more predetermined, localized portions of the adhesive layer at the bondline by applying heat only to the one or more predetermined, localized portions of the assembly to produce an adhesive layer having at least partially cured portions and uncured portions, and the uncured portions of the adhesive layer then can be cured in the subsequent and separate curing step.

In one embodiment, the process of adhering at least a first substrate to at least a second substrate can comprise the steps of: (1) contacting the polyol component and the isocyanate component and mixing the components to form a homogeneous adhesive mixture, e.g., at a temperature of 10-40° C. or 20-30° C.; (2) applying the adhesive mixture to at least a portion of the first substrate; (3) contacting a second substrate with the first substrate such that the mixture is disposed between the first and second substrate forming a bondline; and (4) exposing at least a portion of the mixture to heat under conditions such that the mixture partially cures sufficiently such that the first and second substrate are bonded sufficiently, i.e., with a sufficient strength, such that the substrates can be moved. The process may further comprise a step (5) of heating the two partially cured substrates at a temperature for a time to fully cure the mixture so as to fully bond the two substrates together. The heat may be applied in step (4) by any known heating means such as by infrared heating. The time between steps (4) and (5) may be about 1 hr or more in one embodiment and about 24 hrs or more in another embodiment; and any time in between the above two time periods.

By curing the adhesive composition, a structure is formed comprising two or more substrates bonded together with the cured adhesive based on the curable adhesive formulation where the cured adhesive is disposed between portions of each of the substrates. In one embodiment, the substrates can comprise dissimilar substrates, i.e., substrates of different materials such as metal, e.g., aluminum, uncoated, or uncoated laser pretreated aluminum, glass, plastics, thermoset resins, fiber reinforced plastics, or mixtures thereof. In one preferred embodiment, one or both of the substrates may be fiber reinforced plastic.

### V. Specific Exemplary Embodiments

The following non-limiting embodiments provide specific examples of combinations of materials that can be used together in the first and second components of the adhesive kit. It will be understood that products cured from the components below are contemplated, as are substrates bonded to the cured adhesive, including combinations of substrates bonded together by the cured adhesive therebetween, such as for example one substrate that is inorganic such as a metal (e.g., steel or aluminum, including steel or aluminum that is not coated with a bonding agent but that has been pretreated for corrosion protection for example using e-coating, laser pretreatment, passivation, or TiZr surface pretreatment), and another substrate which is non-metal.

### Exemplary Embodiments

| | |
|---|---|
| Ingredient/Property | % By Weight of Component/Property Range |

First (Isocyanate) Component

| | |
|---|---|
| Monomeric Isocyanate: m-phenylene | 0-40, 1-25, 2-20, 5-20, 10-20, 10-15 |
| diisocyanate; methylene diphenyl diisocyanate | |
| (MDI); 4,4′-methylene-diphenyldiisocyanate; 2,2′- | |
| methylenediphenyldiisocyanate; 2,4-methylene- | |
| diphenyldiisocyanate; toluene diisocyanate (TDI); | |
| toluene-2,4-diisocyanate; toluene-2,6- | |
| diisocyanate; naphthyl-ene-1,5-diisocyanate; | |
| methoxyphenyl-2,4-diisocyanate; diphenyl- | |
| methane-4,4′-diisocyanate; diphenylmethane-2,4′- | |
| diisocyanate; 4,4′-bi-phenylene diisocyanate; 3,3′- | |
| dimethoxy-4,4′-biphenyl diisocyanate; 3,3′- | |
| dimethyl-4-4′-biphenyl diisocyanate; 3,3′-dimethyl- | |
| diphenyl methane-4,4′-diisocyanate; 4,4′,4″- | |
| triphenyl methane triisocyanate; toluene-2,4,6- | |
| triisocyanate; 4,4,-dimethyl-di-phenylmethane- | |
| 2,2,,5,5′-tetraisocyanate; modified versions | |
| thereof; combinations thereof | |
| Polymeric Isocyanate: any derivative or polymer | 0-40, 1-25, 2-20, 5-20, 10-20, 10-15, |
| of the above described monomeric isocynates; | 2-10, 3-8, 4-6 |
| polyisocyanates that contain urethane, urea, | |
| biuret, caibodiimide, uretoneimine, allophonate or | |
| other groups formed by reaction of isocyanate | |
| groups; polymeric MDI (a mixture of MDI and | |
| polyMDI that is commonly referred to as | |
| “polymeric MDF”); “liquid MDI” products that are | |
| mixtures of MDI and polyMDI derivatives that | |
| have biuret, carbodiimide, uretoneimine or | |
| allophonate linkages; aliphatic polyisocyanates | |
| such as those based on | |
| hexamethylenebisisocyanate | |
| Isocyanate-Terminated Prepolymer: isocyanate | 0-40, 1-25, 2-20, 5-20, 10-20, 10-15, |
| prepared by reacting a monomeric or polymeric | 2-10, 3-8, 4-6 |
| isocyanate with a polyol, or a lower molecular | |
| weight diol or triol; polyol used to make the | |
| isocyanate-terminated prepolymer can have a | |
| molecular weight (MW, in g/mol) of from 200 to | |
| 10,000, a MW of from 800 to 8,000, a MW of from | |
| 800 to 6,000, e.g., 200-3,000, 500-3,000, or | |
| 1,000-3,000 g/mol. In addition, the polyol may can | |
| a nominal functionality of from 2 to 3. The polyol | |
| can also have an OH number ranging from 20-80 | |
| mg KOH/g, e.g., 25-75, 30-70, 30-60, or 40-60 mg | |
| KOH/g | |
| MDI end-capped prepolymers formed from EO | |
| (ethylene oxide) or PO (propylene oxide) based | |
| polyols such as polymeric diols, triols, or mixtures | |
| thereof. The resulting prepolymers can have an | |
| equivalent weight (EW) of up to 5,000, from 1,000 | |
| to 4,000, and from 2,000 to 3,500. | |
| Polyol: polypropylene polymers and copolymers, | 0-20, 1-20, 2-20, 3-20, 3-15 |
| e.g., 100-300 g/mol, OH number of 40-60 KOH/g; | |
| polypropylene glycols, e.g., 100-2,000 g/mol; | |
| hydrophobically modified (polybutyleneoxide)diol, | |
| e.g., 1,900-2,000 g/mol, OH number of 40-60 | |
| KOH/g | |
| Catalyst: tin, zinc, bismuth based catalysts, e.g., | 0-2, e.g., 0.005-2, 0.1-1.5, 0.15-0.1.4 |
| zinc alkanoates, bismuth alkanoates, dialkyl tin | |
| alkanoates, dialkyl tin mercaptides, dialkyl tin | |
| bis(alkyl-mercaptoacetates), dialkyltin | |
| thioglycolates (dioctyltinmercaptide, | |
| dibutylmercaptidem, dibutylmercaptide, | |
| dibutylmercaptide, | |
| bis(dodecylthio)dimethylstannane, dimethytin | |
| bis(2-ethylhexylmercaptoacetate), | |
| dioctylcarboxylates, dioctyltinneodecanoate) | |
| thermosensitive amine catalysts such as | |
| TOYOCAT F22 available from TOSOH; | |
| triethylenediamine (TEDA) | |
| any combination of the above | |
| Filler: calcinated clay, calcium carbonate, talc, | 0-60, 10-60,10-30 20-60, 30-60, 30-50, 30-40 |
| glass, silica (e.g., fumed silica), boron oxide, | |
| boron nitride, titanium oxide, titanium nitride, fly | |
| ash, calcium carbonate, and various alumina- | |
| silicates including clays such as wollastonite and | |
| kaolin, metal particles such as iron, titanium, | |
| aluminum, copper, brass, bronze; thermoset | |
| polymer particles such as polyurethane, cured | |
| particles of an epoxy, phenol-formaldehyde, or | |
| cresol-formaldehyde resin, crosslinked | |
| polystyrene; thermoplastics such as polystyrene, | |
| styrene acrylonitrile copolymers, polyimide, | |
| polyamide-imide, polyether ketone, polyether- | |
| ether ketone, polyethyleneimine, poly(p- | |
| phenylene sulfide), polyoxymethylene, | |
| polycarbonate; and various types of carbon such | |
| as activated carbon, graphite, molecular sieve, | |
| carbon black and the like; any combination thereof | |
| Adhesion Promoter: (e.g., silane, aminosilane, | 0.4-5, 0.5-5, 0.6-4, 0.8-4, 2-4 |
| epoxy silane) | |
| Av. NCO equivalent/volume [eq/mL] | 0.1-1, 0.1-0.6, 0.2-0.5 |

Second (Polyol) Component

| | |
|---|---|
| Polyol: polymers and copolymers of propylene | 40-60, e.g., 40-50 |
| oxide, including propylene/ethylene oxide | |
| copolymers; polyetherpolyols, polyester polyols, | |
| glycerin initiated propoxylated and ethoxylated | |
| based triols (MW = 400-3,000 g/mol) | |
| Diol: monoethylene glycol (MEG), diethylene | 1-15, e.g., 2-14, 3-12, 4-10, 5-8, 6-8 |
| glycol, triethylene glycol, 1,2-propane diol, 1,3- | |
| propane diol, 2,3-dimethyl-1,3-propane diol, | |
| dipropylene glycol, tripropylene glycol, 1,4-butane | |
| diol, or 1,6-hexane diol; any combination thereof | |
| Rheology Modifier: polyamine (MW = 100-500 | 0-15, e.g, 0.1-10, 1-5, 2-5, 3-5 |
| g/mol, e.g., trimer Jeffamine T-403, dimer | |
| Jeffamine D-400, dimer Jeffamine D200); any | |
| combination thereof | |
| Catalyst: tin, zinc, bismuth based catalysts, e.g., | 0-2, e.g., 0.005-2, 0.1-1.5, 0.15-0.1.4 |
| zinc alkanoates, bismuth alkanoates, dialkyl tin | |
| alkanoates, dialkyl tin mercaptides, dialkyl tin | |
| bis(alkyl-mercaptoacetates), dialkyltin | |
| thioglycolates (dioctyltinmercaptide, | |
| dibutylmercaptidem, dibutylmercaptide, | |
| dibutylmercaptide, | |
| bis(dodecylthio)dimethylstannane, dimethytin | |
| bis(2-ethylhexylmercaptoacetate), | |
| dioctylcarboxylates, dioctyltinneodecanoate) | |
| thermosensitive amine catalysts such as | |
| TOYOCAT F22 available from TOSOH; | |
| triethylenediamine (TEDA) | |
| any combination of the above | |
| Filler: calcinated clay, calcium carbonate, talc, | 0-60, 10-60, 20-60, 30-60, 30-50, 30-40 |
| glass, silica (e.g., fumed silica), boron oxide, | |
| boron nitride, titanium oxide, titanium nitride, fly | |
| ash, calcium carbonate, and various alumina- | |
| silicates including clays such as wollastonite and | |
| kaolin, metal particles such as iron, titanium, | |
| aluminum, copper, brass, bronze; thermoset | |
| polymer particles such as polyurethane, cured | |
| particles of an epoxy, phenol-formaldehyde, or | |
| cresol-formaldehyde resin, crosslinked | |
| polystyrene; thermoplastics such as polystyrene, | |
| styrene acrylonitrile copolymers, polyimide, | |
| polyamide-imide, polyether ketone, polyether- | |
| ether ketone, polyethyleneimine, poly(p- | |
| phenylene sulfide), polyoxymethylene, | |
| polycarbonate; and various types of carbon such | |
| as activated carbon, graphite, molecular sieve, | |
| carbon black and the like; any combination thereof | |
| Adhesion Promoter: (e.g., silane, aminosilane, | <3, e.g., 0-2.9, 0-2.5, 0-2, 0-1, 0-0.5, 0-0.25, 0 |
| epoxy silane) | |
| OH/NH equivalent/weight [eq/mL] | 0.1-5, 0.2-5, 0.3-4 |

### EXAMPLES

The following examples further illustrate this disclosure. The scope of the disclosure and claims is not limited by the scope of the following examples.

### 1. Materials

Isonate 143, available from the DOW Chemical Company is a modified pure MDI with a functionality of 2.2, a molecular weight of 319 g/mol and a viscosity of 40 mPas.

Voranate 220, available from the DOW Chemical Company is a polymeric MDI with a functionality of 2.7, a molecular weight of 367 g/mol and a viscosity of 220 mPas.

Isonate M342, available from the DOW Chemical Company is a pure modified MDI with a functionality of 2.0, a molecular weight of 360 and a viscosity of 640 mPas.

Desmodur N3400, available from Bayer Materials Sciences is an aliphatic polyisocyanate based on hexamethylenbisisocyanate.

TIB 720 is a bismuth-carboxylate catalyst, available from TIB Chemicals.

Formrez UL29 is a tin based dioctyltinmercaptide catalyst (CAS 26401-97-8) available from Momentive.

1,8-Diazabicyclo[5.4.0]undec-7-ene (“DBU,” CAS 229-713-7) carboxylic acid blocked catalysts, available from TOSOH as TOYOCAT DB41 (carboxylic DBU salt) or from Air Products as POLYCAT SA-102/10 (carboxylic DBU salt).

TOYOCAT F22 is a thermosensitive amine catalyst, available from TOSOH.

Voranol 400 is a polypropylene homopolymer with an average molecular weight of 212 g/mol molecular weight and a OH number of approx. 55 mg KOH/g, available from the DOW Chemical Company.

Voranol 2000L is a polypropylene homopolymer with an average equivalent molecular weight of 1000 g/mol molecular weight and a OH number of approximately 55 mg KOH/g, available from the DOW Chemical Company.

Voranol CP4610 is a glycerin initiated propoxylated and ethoxylated based triol with an average equivalent molecular weight of 1603 g/mol and an OH number of approximately 35 mg KOH/g, available from the DOW Chemical Company.

Poly bd© R20 LM is a liquid hydroxyl terminated polymer of butadiene with a molecular weight of 1300 g/mol and a polydispersity of 2, available from Cray Valley.

VORAPEL D3201 is a hydrophobically modified (polybutyleneoxide)diol with an average molecular weight of 1921-2125 g/mol and an OH number of approx. 56 mg KOH/g, available from the DOW chemical Company.

Poly THF is a poly(tetramethylene-oxide)diol with a molecular weight of 1950-2050 g/mol and a hydroxyl number of 54.7-57.5.

1,4 butandiol is purchased from Arco Chemical and distributed from Schweizerhall Chemie. MEG is monoethylene glycol, available from the DOW Chemical Company.

KaMin 100C (IMERYS) is pre-dried calcined China clay (55% SiO₂, 45% Al₂O₃) with an average particle size of approx. 2 μm (90%>10 μm), a BET surface of 8.5 m²/g and a pH of 6.0-6.5.

Aerosil R 202 is hydrophobically modified polydimethylsiloxane coated fumed silica, available from Evonik Industries.

Silquest A 187=gamma-glycidoxypropyltrimethoxysilane available from Momentive Performance Materials.

Silquest A 189 is gamma-mercaptopropyltrimethoxysilane available from Momentive Performance Materials

Dynasylan GLYEO is gamma-glycidoxypropyltriethoxysilane available from Evonik.

### II. Methods

Rheology: Rotatory viscosity/yield stress: Bohlin CS-50 Rheometer, C/P 20, up/down 0.1-20 s⁻¹; evaluation according to Casson model.

Thermal analysis: Dynamic Mechanical Analysis DMA: Glass transition temperature, Tg, was determined by DMA measurement and defined as the maximum of the tan δ. Test method: Temperature range: −40° C. to +150° C.; frequency: 1 Hz; heating rate: 3° C./min.

Lap shear strength according to DIN EN 1465:2009: on laser pretreated aluminum 5182 with substrate thickness 1 mm; Substrate laser pretreatment has been conducted by cleanLASER (Herzogenrath, Germany) using a CL 600 Laser System; or on e-coated steel CR4, cleaned with heptanes; 10×25 mm bonded area, 1 mm adhesive layer thickness. The Failure mode after lap shear testing is analyzed and categorized by cohesive failure (CF) and adhesive failure (AF) as well as corrosion failure (COR). Values are rounded to multiples of 10%.

Lap shear strength testing after 3000 h salt spray was conducted similar to the specimens initially only with an exposure to a salt spray environment prior to testing for a defined time. After 7 d cure at RT the specimens have been stored for 3000 h in a salt spray chamber (5% NaCl in deionized water)

Tensile test (DIN ISO EN-527-1:2012-06): A plate of the cured adhesive is prepared in a thickness of 2 mm and cured at room temperature for 7d. Dog bone shaped specimens are cut out of the plate. The dimensions are according to DIN ISO EN-527-1 and the test is performed accordingly an a Zwick tensile tester.

### III. Discussion

This disclosure focuses on the isocyanate component of the two component polyurethane adhesive. The polyol component formulations are described in Table 1. In Table 2, the differences between comparative and inventive recipes of the isocyanate components are summarized. The physical data, particularly lap shear strength initially, and after 3000 h salt spray corrosion on laser pretreated steel, as well as Young's modulus, shear strength, and elongation are summarized in Table 3. The data refer to mixed two-component (2K) polyurethane adhesives, based on a 1:1 mixture of the specified poly and isocyanate components. The polyol components are differentiated by the presence of an epoxy silane in the formulation. The PolyC1 formulation contains 3% of the epoxy silane, while PolyC2 is void of any epoxy silane.

TABLE 1
Recipes of Polyol component.

| | Inv. PolyC 1 | PolyC 2 |
|---|---|---|
| Technology | with Silan | without Silan |
| | Wt % | Wt % |
| VORANOL CP 4610 | 47.99 | 49.14 |
| MEG | 7.2 | 7.05 |
| JEFFAMIN T-403 | 3.5 | 3.5 |
| JEFFAMIN D-400 | | |
| FOMREZ UL-29 | 0.07 | 0.07 |
| TOYOCAT DB 40 | 0.45 | 0.45 |
| DABCO LV 33 | 0.09 | 0.09 |
| MONOMIX G | 35.5 | 37.5 |
| KAMIN 100 C | | |
| SILQUEST A 187 | 3.0 | — |
| molecular sieve | 1.0 | 1.0 |
| AEROSIL R 202 | 1.2 | 1.2 |
| OH/NH equivalent/weight [eq/mL] | 0.374 | 0.375 |

The isocyanate formulations are differentiated by the presence of a silane for the inventive formulations vs. the reference formulations containing no silane.

The reference formulation Ref. IsoC1 vs. Ref. IsoC2 are differentiated by the polyol used in the prepolymer synthesis. Ref. IsoC2 contains Vorapel D3201, a hydrophobic polyol, in the prepolymer compared to the less hydrophobic Voranol 1010L. Except for Inv. IsoC9 the hydrophobic polyol is used in all inventive examples.

The inventive Inv. IsoC 8 is based on formulation Ref. IsoC 2 with addition of 3% of an epoxy silane.

Inv. IsoC 3 is also based on formulation Ref. IsoC 2 with addition of 3% of an epoxy silane and an additional amount of isocyanates which is increased with a higher content of M220. The amount is chosen the way that every methoxy group that is present in the 3% of silane could be reacted with an additional isocyanate group and still the index NCO/OH compared to the reference without silane would be same.

Ref. IsoC 6 is comparing to Inv. IsoC 3 just without addition of Silane.

Inv. IsoC 4 is comparable Inv. IsoC 3 containing a mercapto silane instead of an epoxy silane.

Inv. IsoC 5 is comparable to Inv. IsoC 3 containing a gamma-glycidoxypropyltri-ETHOXY-silane instead of a gamma-glycidoxypropyltri-METHOXY-silane.

Ref IsoC 7 is based on Ref. IsoC 6 but contains the same amount of Methanol that is present in the 3% silane in the Inv. IsoC 3 to show that the positive effect is based on the silane and not the addition of monofunctional alcohols.

Inv. IsoC9 contains the more hydrophilic polyol voranol 1010L instead of Vorapel D 3201 in Inv. IsoC3 to show that the positive effect of adhesion to laser pretreated aluminum is not an effect of the hydrophobic prepolymer.

TABLE 2
Inventive/Reference Recipies of Isocyanate Component

| | Ref. | Ref. | | |
|---|---|---|---|---|
| | IsoC | IsoC | Inv. | Ref |
| | 1 | 2 | IsoC 8 | IsoC 6 |
| technology | | | Ref. | Ref. |
| | | | IsoC 2 | IsoC 2 |
| | | | With epoxy Silan but | With increased |
| | | | no increase in NCO | NCO |
| ISONATE M 143 | 13.95 | 12.05 | 12.05 | 12.05 |
| DESMODUR N 3400 | 5.0 | 4.85 | 4.85 | 4.85 |
| VORANATE M 220 | 35.0 | 35.0 | 35.0 | 43.65 |
| VORANOL 400 | 4.70 | 4.85 | 4.85 | 4.85 |
| VORANOL 1010L | 11.90 | | | |
| VORAPEL D 3201 | | 12.2 | 12.2 | 12.2 |
| lospur-SA-20735/9121 black | 0.15 | 0.15 | 0.15 | 0.15 |
| paste | | | | |
| SILQUEST A 187 | | | 3.0 | |
| SILQUEST A 189 | | | | |
| DYNASILAN GLYEO | | | | |
| Methanol | | | | |
| KAMIN 100 C | 27.8 | 29.15 | 26.15 | 20.5 |
| AEROSIL R 202 | 1.5 | 1.75 | 1.75 | 1.75 |
| Av. NCO equivalent/volume * | 0.461 | 0.461 | | |
| [eq/mL] | | | | |

| | Inv. | Inv. | Inv. | Ref | Inv. |
|---|---|---|---|---|---|
| | IsoC 3 | IsoC 4 | IsoC 5 | IsoC 7 | IsoC 9 |
| technology | Ref | Ref. | Ref. | Ref. | Inv. |
| | IsoC 6 | IsoC 6 | IsoC 6 | IsoC 6 | IsoC 3 |
| | with | with | with epoxy | Without Silane + | with 1010L in |
| | epoxy | mercapto- | ethoxy silan | Methanol | prepolymer |
| | silan | silan | | | |
| ISONATE M 143 | 12.05 | 12.05 | 12.05 | 12.05 | 12.05 |
| DESMODUR N 3400 | 4.85 | 4.85 | 4.85 | 4.85 | 4.85 |
| VORANATE M 220 | 43.65 | 43.65 | 43.65 | 43.65 | 46.0 |
| VORANOL 400 | 4.85 | 4.85 | 4.85 | 4.85 | 4.85 |
| VORANOL 1010L | | | | | 12.2 |
| VORAPEL D 3201 | 12.2 | 12.2 | 12.2 | 12.2 | |
| lospur-SA-20735/9121 | 0.15 | 0.15 | 0.15 | 0.15 | 0.15 |
| black paste | | | | | |
| SILQUEST A 187 | 3.0 | | | | 3.0 |
| SILQUEST A 189 | | 3.0 | | | |
| DYNASILAN GLYEO | | | 3.0 | | |
| Methanol | | | | 1.2 | |
| KAMIN 100 C | 17.5 | 17.5 | 17.5 | 19.3 | 13.4 |
| AEROSIL R 202 | 1.75 | 1.75 | 1.75 | 1.75 | 3.5 |
| Av. NCO equivalent/ | 0.462 | | | 0.462 | |
| volume * [eq/mL] | | | | | |

* for silane components in the NCO component, the equivalents have been calculated based on the assumption that the methoxy groups of the silane fully react directly with isocyanates.

TABLE 3
Young's modulus, shear strength, and elongation at break at ambient
temperature of 1:1 mixed inventive and comparative Examples

| | Ref. | Ref. | | |
|---|---|---|---|---|
| | Example | Example | | Ref. Example |
| | 1 | 2 | Inv. Example 3 | 4 |
| | Ref. | Ref. | Inv. | Ref |
| | IsoC 1 | IsoC 2 | IsoC 8 | IsoC 6 |
| technology | | | With Silan but no increase in | Without |
| | | | NCO | Silan |
| | PolyC 1 | PolyC 1 | PolyC 2 | PolyC 2 |
| technology | with Silan | with Silan | without Silan | without Silan |
| Elastic modulus | 90 ± 10 | 174 ± 8 | 207 ± 3 | 547 ± 29 |
| 7d rt | | | | |
| [MPa] | | | | |
| Tensile Strength | 13.5 ± 0.3 | 13.5 ± 0.3 | 12.9 ± 0.2 | 18.8 ± 0.4 |
| 7d rt | | | | |
| [MPa] | | | | |
| Elongation at break | 84 ± 6 | 64 ± 4 | 69.0 ± 1.8 | 74.6 ± 0.6 |
| 7d rt | | | | |
| [%] | | | | |
| LSS e-coated steel | n.d. | n.d. | 18.7 ± 0.3 | 16.0 ± 0.6 |
| Initial 7d rt | | | | |
| [MPa] | | | | |
| LSS laser pretreated | 13.4 ± 0.4 | 13.1 ± 0.9 | 14.0 ± 0.5 | 12.3 ± 0.7 |
| aluminum | | | | |
| Initial 7d rt | | | | |
| [MPa] | | | | |
| LSS laser pretreated | 7.8 ± 0.9 | 9.4 ± 0.1 | 13.8 ± 0.4 | 11.7 ± 0.7 |
| aluminum | 100 AF | 100 AF | 100 CF | 100 AF |
| 7d rt + 3000h SS | | | | |
| [MPa] | | | | |

| Inv. Example | Inv. | Inv. | Inv. | Ref. | Inv. |
|---|---|---|---|---|---|
| 5 | Example 6 | Example 7 | Example 8 | Example 9 | Example 10 |
| Inv. | Inv. | Inv. | Inv. | Ref | Inv. |
| IsoC 3 | IsoC 3 | IsoC 4 | IsoC 5 | IsoC 7 | IsoC 9 |
| Methoxy- | Methoxy- | Mercapto- | Ethoxy- | without | with 1010L and |
| silane | silane | silan | silan | Silan with | Silan |
| | | | | Methanol | |
| PolyC 2 | PolyC 1 | PolyC 2 | PolyC 2 | PolyC 2 | PolyC 2 |
| without Silan | with Silan | without Silan | without | without Silan | without Silan |
| | | | Silan | | |
| 402 ± 15 | 231 ± 7 | 434 ± 27 | 405 ± 6 | 515 ± 15 | 262 ± 6 |
| 18.3 ± 0.0 | 17.5 ± 0.4 | 18.2 ± 0.1 | 17.2 ± 0.0 | 18.5 ± 0.2 | 16.6 ± 0.7 |
| 80 ± 1 | 98 ± 4 | 79.9 ± 2 | 74.2 ± 4 | 72.5 ± 3 | 83.7 ± 6 |
| 14.4 ± 00 | 15.6 ± 0.8 | 15.6 ± 08 | 16.0 ± 1.0 | 8.6 ± 2 | 12.1 ± 1.1 |
| 13.3 ± 0.7 | 11.1 ± 0.0 | 16.3 ± 0.2 | 16.0 ± 0.4 | 5.8 ± 3 | 13.1 ± 0.5 |
| 15.2 ± 0.2 | 11.4 ± 0.2 | 16.9 ± 0.7 | 16.3 ± 0.2 | 12.0 ± 1 | 13.9 ± 0.3 |
| 100 CF | 100 CF | 100 CF | 100 CF | 100 AF | 100 CF |

*AF—Adhesive Failure; CF = Cohesive Failure

In Table 3 the results for the full tests of the different inventive and reference isocyanate components tested with the two polyol components. The benefit addressed in this invention is the cohesive failure mode of the adhesive after a salt spray corrosion of 3000 hours on a laser pretreated aluminum in combination with a lap shear strength of above 10 MPa more preferred even more than 12 MPa.

Ref Example 1 and 2 containing the silane in the polyol component show all three 100% adhesive failure after 3000 h salt spray. In addition, the lap shear strength is with below 10 MPa, which is insufficient for certain applications. The presence of a silane in the polyol component of the adhesive formulation is not having a positive effect on adhesion to laser pretreated aluminum; comparing the inventive examples 5 and 6 it shows a slightly negative effect when the silane is present in the PolyC.

Inventive Example 3 with the epoxy silane in the Isocyanate component shows a fully cohesive failure mode even after 3000 h salt spray and with 13.8 MPa and no loss in lap shear strength.

Inventive examples 5, 7 and 8 containing the increased amount of NCO in the formulation and different kinds of silanes all show fully cohesive failure mode as well as a full retention of lap shear strength after 3000 h salt spray. This indicates the positive effect of the presence of a silane in the isocyanate component.

Inventive Example 6 that contains silane in both components shows a fully cohesive failure mode but with only 11 MPa, a lower lap shear strength than the other inventive examples.

Ref Example 4 containing the increased amount of NCO in the isocyanate component and no silane in both components shows after the corrosion cycle of 3000 h salt spray a full adhesion failure rendering the formulation not acceptable. This is indicating that the positive effect of adhesion is not an effect of the increased NCO content in the formulation.

Ref Example 9 with the added methanol in the Isocyanate component and no silane in both components shows after the corrosion cycle of 3000 h salt spray a full adhesion failure rendering the formulation not acceptable. This is indicating the that positive effect of adhesion to laser pretreated aluminum is not an effect of the endcapping of the polymer with methanol but the presence of silane in the isocyanate component.

Inventive examples 9 containing the more hydrophilic polyol in the prepolymer of the isocyanate component still shows fully cohesive failure mode as well as a full retention of lap shear strength after 3000 h salt spray. This indicates that the positive effect of adhesion is due to the presence of a silane in the isocyanate component and can also be seen with different prepolymers of different chemistry.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

1. An uncured adhesive formulation comprising:
a) a first component comprising an isocyanate and 0.4% to 5% of a silane adhesion promoter by weight of the first component; and
b) a second component comprising i) 10% to 80% of a polyol by weight of the second component, the polyol having a molecular weight of at least 400 g/mol, and ii) 1% to 15% of a diol by weight of the second component, the diol having a molecular weight of 200 g/mol or less; wherein the second component comprises less than 3% of a silane adhesion promoter by weight of the second component;
wherein the uncured adhesive formulation is in the form of a kit in which the first and second components are not mixed.

2. The adhesive formulation of claim 1, wherein the second component comprises less than 2.5%, of the silane adhesion promoter by weight of the second component.

3. The adhesive formulation of claim 1, wherein the second component does not comprise any aminosilane.

4. The adhesive formulation of claim 1, which does not comprise any aminosilane.

5. The adhesive formulation of claim 1, further comprising a catalyst capable of catalyzing the reaction of a hydroxyl group with an isocyanate group.

6. The adhesive formulation of claim 1, wherein the isocyanate is a monomeric isocyanate, a polymeric isocyanate, an isocyanate-terminated prepolymer, or a combination thereof.

7. The adhesive formulation of claim 1, wherein the polyol is a diol or a glycerin-initiated triol having residues of ethylene oxide, propylene oxide, or a combination thereof; and wherein the polyol has a molecular weight ranging from 400 g/mol to 3,000 g/mol.

8. The adhesive formulation of claim 1, wherein the diol has the formula CₓH_{y}O_{z}, where x is an integer ranging from 2 to 20, y is an integer equal to x+m (m being an integer ranging from 4 to 12), and z is an integer equal to x−n (n being an integer ranging from 0 to 6).

9. The adhesive formulation of claim 1, further comprising 0.1% to 80% of a filler by weight of the adhesive formulation.

10. (canceled)

11. A process for curing the adhesive formulation of claim 1, comprising mixing the first and second components of the adhesive formulation and allowing the mixture to cure.

12. The process of claim 11, wherein the first and second components of the adhesive formulation are mixed at a ratio ranging from 2:1 to 1:2.

13. The process of claim 12, wherein the first and second components of the adhesive formulation are mixed at a ratio of 1:1.

14. The process of claim 11, wherein the first and second components of the adhesive formulation are mixed at a temperature ranging from 10° C. to 40° C.

15. The process of claim 14, wherein the first and second components of the adhesive formulation are mixed at a temperature ranging from 20° C. to 30° C.

16. (canceled)

17. (canceled)

18. The process of claim 11, further comprising applying the mixture to an inorganic substrate prior to allowing the mixture to fully cure.

19. The process of claim 18, wherein the substrate is an uncoated, corrosion-protected aluminum or steel substrate.

20. The process of claim 18, further comprising bonding the inorganic substrate having the mixture applied thereon to a second substrate that is not inorganic prior to allowing the mixture to fully cure, to form a bonded assembly.
